(19) United States
(12) Patent Application Publication
(10) Pub. No.: US 2024/0144567 A1
(43) Pub. Date: May 2, 2024

(54) METHOD AND SYSTEM FOR ANIMATING HAIR WITH RESOLUTION INDEPENDENT FIBER DEFORMATION

(71) Applicants: Gene Wei-Chin LIN, Vancouver (CA); Giorgio LAFRATTA, Vancouver (CA); Rafe SACKS, Vancouver (CA); Nathan FOK, Vancouver (CA)

(72) Inventors: Gene Wei-Chin LIN, Vancouver (CA); Giorgio LAFRATTA, Vancouver (CA); Rafe SACKS, Vancouver (CA); Nathan FOK, Vancouver (CA)

(73) Assignee: Digital Domain Virtual Human (US), Inc., Los Angeles, CA (US)

(21) Appl. No.: 18/410,892

(22) Filed: Jan. 11, 2024

Related U.S. Application Data
(63) Continuation of application No. PCT/CA2022/050671, filed on May 2, 2022.
(60) Provisional application No. 63/225,438, filed on Jul. 23, 2021.

(51) Int. Cl. G06T 13/20

(52) U.S. Cl. CPC G06T 13/20

(57) ABSTRACT

A method for animating fibers in a computer-based animation process, the method comprises: obtaining a fiber cache comprising a plurality of fibers, each of the plurality of fibers comprising a plurality of fiber vertices; obtaining one or more guides, each of the one or more guides comprising a plurality guide vertices; and determining binding information to bind the one or more guides to the fiber cache. Determining the binding information comprises, for each fiber of the fiber cache: associating the fiber with one or more nearby guides; and, for each of the one or more associated nearby guides: associating each fiber vertex with a nearby guide vertex; and determining, for each fiber vertex, a displacement vector between the fiber vertex and the associated nearby guide vertex.

### REFERENCE TO RELATED APPLICATIONS

This application is a continuation of Patent Cooperation Treaty (PCT) application No. PCT/CA2022/050671 having an international filing date of 2 May 2022 which in turn claims priority from, and for the purposes of the Untied States the benefit under 35 USC 119 in connection with, U.S. application Ser. No. 63/225438 filed 23 Jul. 2021. All of the applications referred to in this paragraph are hereby incorporated herein by reference.

### TECHNICAL FIELD

This application relates to computer-based graphical simulation and animation. Particular embodiments provide methods and systems for computer-based graphical simulation and animation and/or manipulation of one or more fibers of a fiber system.

### BACKGROUND

In traditional animation, animators begin by drawing sequences on sheets of transparent paper one frame at a time. The frames are then stitched together to create moving images. Realistic animation of characters (e.g. life-like human characters, animal characters, humanoid characters, invented characters, etc.) is typically achieved through the use of talented artists and a significant amount of time and resources.

Computer-based graphical simulation seeks to reduce the time and resources of traditional animation. For computer-based graphical simulation, each individual strand of a character's hair may be represented by a plurality of interconnected vertices extending from a surface (sometimes referred to as a “mesh”) of the character. Adjacent vertices of the hair are connected by segments or rods. By changing the relative location of the vertices and/or the orientation of the segments, different hair styles can be achieved. Since a character may have thousands of simulated strands of hairs and each simulated strand of hair may comprise hundreds of vertices/segments, it can be time consuming to arrange the simulated strands of hair into a desired hair style.

Procedural animation is a type of computer-based animation used to automatically generate animation in real-time to allow for a diverse series of actions. Procedural animation is commonly used to simulate fiber systems, such as hair, fur, grass, etc.

Procedural animation may rely on a node graph architecture which employs modular node components which can be connected to form a graph. Each type of node component may perform a specific task. For example, a simplified node graph for hair may comprise a “distribute node” to distribute the locations of hair strands across a character's scalp, a “generate node” to generate strands of hair at each location specified by the distribute node and a “deform node” to shape each strand of hair generated at the generate node. The node graph may comprise a number of other nodes for setting strand length, strand thickness, strand colour, strand clumping, etc.

Especially as a node graph becomes more complex, it can become computationally expensive to repeatedly render a node graph at various steps throughout an animation workflow.

There is a desire for improved methods for animation workflows for animating fiber systems, such as hair, fur, grass, etc. (e.g. to manipulate such fiber systems), that are less computationally expensive than current procedural animation techniques which rely on repeatedly updating and rendering node graphs throughout an animation workflow.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method for animating fibers in a computer-based animation process. The method comprises: obtaining a fiber cache comprising a plurality of fibers, each of the plurality of fibers comprising a plurality of fiber vertices; obtaining one or more guides, each of the one or more guides comprising a plurality guide vertices; determining binding information to bind the one or more guides to the fiber cache wherein determining the binding information comprises, for each fiber of the fiber cache: associating the fiber with one or more nearby guides from among the one or more guides; and for each of the one or more associated nearby guides: associating each fiber vertex of the fiber with a nearby guide vertex of the associated nearby guide; and determining, for each fiber vertex of the fiber, a displacement vector between the fiber vertex and the associated nearby guide vertex.

The method may comprise manipulating at least one of the one or more guides, wherein manipulating the at least one of the one or more guides comprises changing a location of one or more guide vertices of the at least one of the one or more guides.

Manipulating at least one of the one or more guides may be based at least in part on user input.

Manipulating at least one of the one or more guides may be based at least in part on an automated animation simulation.

Manipulating at least one of the one or more guides may comprises receiving an indication of a displacement region and a displacement vector.

Manipulating at least one of the one or more guides may comprise displacing the vertices of any guides having one or more vertices in the displacement region by a displacement corresponding to the displacement vector.

Manipulating at least one of the one or more guides may comprise displacing any vertices of any guides located in the displacement region by a displacement corresponding to the displacement vector.

Manipulating the at least one of the one or more guides may comprise changing the location of the one or more guide vertices of the at least one of the one or more guides based at least in part on the indication of the region and the displacement vector according to any one of the methods set out in U.S. patent application Ser. No. 63/163025, filed 18 Mar. 2021.

Obtaining the one or more guides may comprise extracting the one or more guides from the fiber cache by selecting one or more fibers from among the plurality of fibers of the fiber cache to be the one or more guides.

Extracting the one or more guides from the fiber cache may comprise: filtering out one or more of: fibers of the plurality of fibers of the fiber cache having a length within, or outside of, a threshold range; a threshold percentage of fibers of the plurality of fibers of the fiber cache while maintaining a minimum spacing between remaining fibers of the plurality of fibers of the fiber cache; fibers of the plurality of fibers of the fiber cache having one or more shape characteristics within, or outside of, a range of shape characteristics; fibers of the plurality of fibers of the fiber cache having a curvature within, or outside of, a range of curvature; and fibers of the plurality of fibers of the fiber cache that are dissimilar to other nearby fibers of the plurality of fibers of the fiber cache. Extracting the one or more guides from the fiber cache may comprise: selecting the one or more fibers from among the remaining fibers of the plurality of fibers of the fiber cache to be the one or more guides.

The plurality of fiber vertices for each of the plurality of fibers may comprise a root fiber vertex and one or more other fiber vertices. The plurality of guide vertices for each of the one or more guides may comprise a root guide vertex and one or more other guide vertices. For each fiber of the fiber cache, associating the fiber with one or more nearby guides from among the one or more guides may comprise identifying, as the one or more nearby guides, any of the one or more guides with root guide vertices that are within a threshold distance of a root fiber vertex of the fiber.

The threshold distance may be user-configurable.

The plurality of fiber vertices for each of the plurality of fibers may comprise a root fiber vertex and one or more other fiber vertices. The plurality of guide vertices for each of the one or more guides may comprise a root guide vertex and one or more other guide vertices. For each fiber of the fiber cache, associating the fiber with one or more nearby guides from among the one or more guides may comprise identifying the one or more nearby guides based at least in part on a distance between a root fiber vertex of the fiber and root guide vertices of each of the one or more guides.

Identifying the one or more nearby guides based at least in part on the distance between the root fiber vertex of the fiber and root guide vertices of each of the one or more guides may comprise identifying a threshold number of the one or more guides having the lowest distances between the root fiber vertex of the fiber and the root guide vertices of the guides to be the one or more nearby guides.

The threshold number may be user configurable.

For each fiber of the fiber cache and for each of the one or more associated nearby guides, associating each fiber vertex of the fiber with a nearby guide vertex of the associated nearby guide may comprise, for each fiber vertex of the fiber and for the associated nearby guide, selecting, as the nearby guide vertex, the guide vertex of the associated guide that is closest to fiber the vertex of the fiber.

The method may comprise: updating the fiber cache based at least in part on the binding information to obtain an updated fiber cache. The binding information may comprises, for each fiber of the fiber cache: the one or more associated nearby guides; and for each of the one or more associated nearby guides: the associated nearby guide vertex for each fiber vertex; and the displacement vector between each fiber vertex and its associated nearby guide vertex.

Updating the fiber cache based at least in part on the binding information may comprise, for each fiber vertex of each fiber of the fiber cache, obtaining an updated fiber vertex position, p*, according to:

p*=Σᵢ₌₁ⁿwᵢ(pᵢ+vᵢ)

where i is a guide index, n is the number of nearby guides associated with the fiber, pᵢ is the position of the associated nearby guide vertex of the i^{th} guide associated with the fiber vertex of the fiber, vᵢ is the displacement vector between the fiber vertex of the fiber and the associated nearby guide vertex of the i^{th} guide associated with the fiber vertex of the fiber, and wᵢ is obtained according to:

$${w}_{i} = \frac{{r}_{i}}{W}$$

$$where :$$

$${r}_{i} = \frac{1}{\vert {v}_{i} \vert}$$

$$and$$

$$W = {\sum }_{i = 1}^{n} {r}_{i} .$$

The method may comprises rendering a frame of animation comprising the plurality of fibers based at least in part on the updated fiber cache.

The method may comprise rendering a frame of animation comprising the plurality of fibers based at least in part on the fiber cache and the binding information. The binding information may comprises for each fiber of the fiber cache: the one or more associated nearby guides; and for each of the one or more associated nearby guides: the associated nearby guide vertex for each fiber vertex; and the displacement vector between each associated nearby guide vertex and each fiber vertex.

Rendering the frame of animation comprising the plurality of fibers based at least in part on the fiber cache and the binding information may comprise employing both the fiber cache and the binding information at the time of rendering.

Another aspect of the invention provides a system for animating fibers in a computer-based animation process. The system comprises a processor configured (e.g. by suitable programming) to: obtain a fiber cache comprising a plurality of fibers, each of the plurality of fibers comprising a plurality of fiber vertices; obtain one or more guides, each of the one or more guides comprising a plurality of guide vertices; and determine binding information to bind the one or more guides to the fiber cache wherein to determine the binding information, the processor is configured (e.g. by suitable programming) to, for each fiber of the fiber cache: associate the fiber with one or more nearby guides from among the one or more guides; and, for each of the one or more associated nearby guides: associate each fiber vertex of the fiber with a nearby guide vertex of the associated nearby guide; and determine, for each fiber vertex of the fiber, a displacement vector between the fiber vertex and the associated nearby guide vertex.

The processor may be configured to perform any of the features, combinations of features and/or sub-combinations of features of the method discussed above and elsewhere in this disclosure.

Another aspect of the invention provides a computer program product embodied on a non-transitory computer readable medium having stored thereon software instructions that, when executed by a processor, cause the processor to perform any of the methods discussed above and elsewhere in this disclosure.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 depicts a method for manipulating a fiber cache according to one exemplary non-limiting embodiment of the invention.

FIG. 2 is a schematic depiction of a user interface for manipulating a fiber cache according to one exemplary non-limiting embodiment of the invention.

FIG. 3 depicts a method for binding one or more guides to a fiber cache according to one exemplary non-limiting embodiment of the invention.

FIG. 4A is a schematic depiction of a relationship between root vertices of a fiber and a plurality of guides according to one exemplary non-limiting embodiment of the invention.

FIG. 4B is a schematic depiction of a relationship of a fiber and a guide according to one exemplary non-limiting embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides an improved computer-simulation based animation workflow for fiber systems. Like other animation systems, a fiber system may be created by an artist employing procedural animation. However, unlike other animation systems which continue to rely on a node graph (and therefore may require repeated rendering (and associated computation) of the node graph) throughout the animation workflow, aspects of the invention provide methods for converting a node graph of a fiber system into a fiber cache and methods for manipulating the fiber cache for use throughout an animation workflow. The fiber cache may be manipulated in response to manipulation of one or more guide fibers (or guides). Once manipulated, the fiber cache may be rendered.

To reduce computational expense of simulation of a fiber system (e.g. hair, fur, grass, etc.), a node graph for a fiber system may be converted into a fiber cache. The fiber cache comprises a database of positional information for each individual fiber of the fiber system. For example, each fiber may be represented by a series of vertex positions, which, when connected in sequence, re-create the fiber, allowing the fiber to be rendered. Rendering the fiber cache may be significantly less computationally expensive than rendering the node graph. To assist in replacing a node graph with a fiber cache in an animation workflow, one aspect of the invention provides a method of manipulating the fiber cache to allow for modifications to one or more fibers of the simulated fiber system.

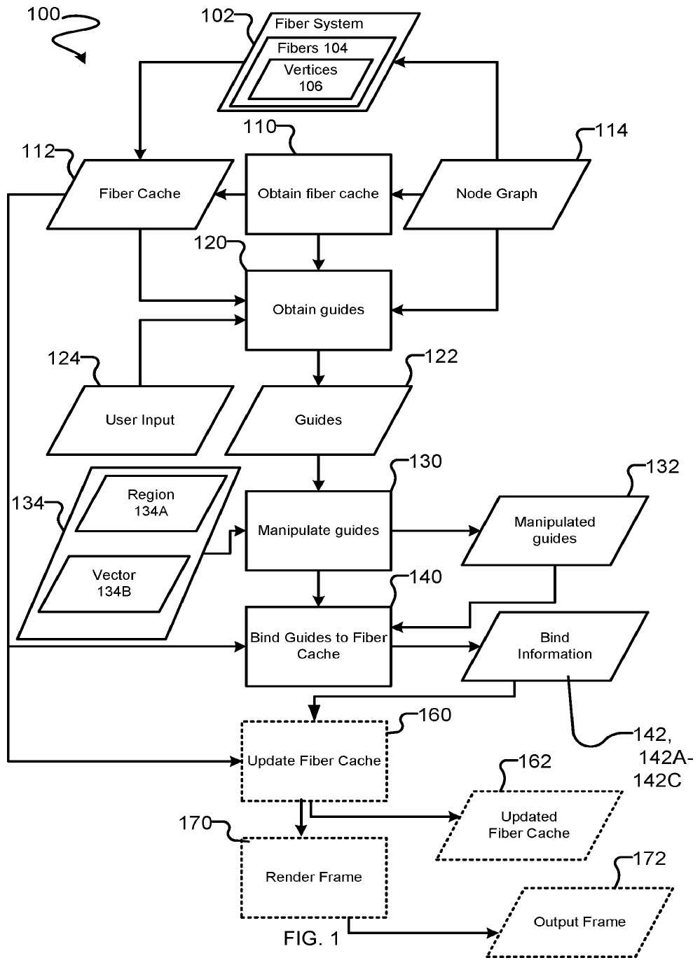

FIG. 1 depicts an exemplary non-limiting method 100 of manipulating a fiber cache which may be used in an animation workflow in accordance with a particular exemplary embodiment. Method 100 begins at step 110 with obtaining a fiber cache 112 of a fiber system 102. Fiber system 102 may comprise any suitable fiber system, such as fur, hair, grass, etc. Fiber cache 112 may have been previously created or may be created at step 110.

In some embodiments, fiber system 102 may be created from a node graph 114. In such embodiments, fiber cache 112 may be created by extracting and recording positional data of each vertex of each fiber 104 of fiber system 102 directly from node graph 114. In some embodiments, fiber cache 112 is provided as input to method 100 from some suitable external system, from an artist and/or the like. In some embodiments, such an external system, artist and/or the like may manipulate fiber cache 112 prior to fiber cache being used by method 100. For example, fiber cache 112 may be manipulated during the process of extraction from fiber system 102 or after extraction from fiber system 102. Fiber cache 112 may be obtained in step 110 by any suitable method and used as input for the remainder of method 100.

Fiber cache 112 may comprise a database of vertex positions and optionally, width, colour, texture and/or other properties for each fiber 104 of fiber system 102. In some embodiments, fiber cache 112 comprises a binary file.

Once fiber cache 112 is obtained at step 110, method 100 continues to step 120, where guides 122 are obtained. In some embodiments, guide fibers (or guides) 122 are obtained or may otherwise be known prior to implementing method 100. In some embodiments, guides 122 are extracted from node graph 114. In some embodiments, guides 122 are extracted from fiber cache 112.

Guides 122 may optionally be extracted from fiber cache 112 based on user input 124. For example, a user may choose specific fibers of fiber system 102 to act as guides 122. One or more filters may be applied to fiber system 102 to aid a user in choosing fibers from among the fibers of fiber cache 112 to act as guides 122. Such filters may reduce the number of fibers to choose from based at least in part on one or more of fiber density, fiber length, fiber curvature, and/or the like. For example, the filters may be employed to identify:
fibers 104 having a length within, or outside of, a particular range (which may be a user- or otherwise configurable range);
a particular percentage (which may be a user- or otherwise configurable percentage) of fibers 104 of fiber system 102 while, optionally, maintaining a minimum (which may be a user- or otherwise configurable minimum) spacing between remaining fibers and/or between guides 122;
fibers 104 having one or more shape characteristics within, or outside of, a particular range (which may be a user- or otherwise configurable range) of shape characteristics;
fibers 104 having a curvature within, or outside of, a particular range (which may be a user- or otherwise configurable range) of curvature;
fibers 104 that are dissimilar to other nearby fibers 104; and/or the like.
   With fewer fibers to choose from, a user and/or a suitably configured software routine may more easily pick fibers 104 to act as guides 122. For example, a user may pick fibers 104 to act as guides by selecting individual fibers 104 or selecting regions having one or more fibers 104. User input 124 in the step 120 guide selection process may be useful to permit animation artists to have maximum flexibility. It will be appreciated that in certain applications (for example, where automation is paramount over artistic freedom), the step 120 process of selecting guides 122 may be automated by suitably configured software (e.g. a random fiber selector or a fiber selector configured to use some other selection process). In some embodiments, filtering of the type described above is employed to automatically pick fibers 104 to act as guides 122 using a suitably configured software routine without user input 124.

Once guides 122 are obtained, method 100 continues to step 130, where guides 122 are manipulated to create manipulated guides 132. At step 130, guides 122 are manipulated by changing a location of one or more vertices of one or more guides 122 to create manipulated guides 132. Guides 122 may be manipulated using any suitable techniques, methods or tools. In some embodiments, guides 122 are manipulated by a user employing a user interface brush tool, which simulates the effect of brushing the guides 122. In some embodiments, guides 122 are manipulated in block 130 by some suitable automated or semi-automated animation/simulation process which solves for, or otherwise prescribes, suitable animations for manipulating guides 122.

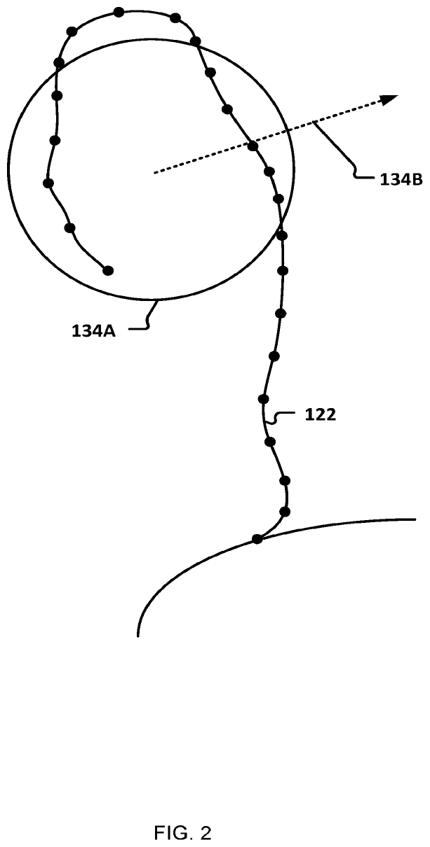

In some embodiments, guides 122 are manipulated according to user input 134. User input 134 may comprise an indication of a region 134A to be manipulated and a displacement vector 134B indicating the direction and magnitude of manipulation. When a user manipulates the aforementioned brush tool on their screen, the brush tool may generate region 134A and displacement vector 134B. FIG. 2 shows an exemplary guide 122, region 134A and displacement vector 134B. Region 134A may define the size, shape and location of a region in or around which it is desirable to manipulate one or more vertices of a guide 122. While region 134A is depicted herein in two dimensions with a circular shape, it should be understood that region 134A may be a three-dimensional space and need not be circular or spherically shaped. Displacement vector 134B may define the magnitude and direction of a desired manipulation of guide 122 (or one or more portions of guide 122) that are within or near region 134A. For example, all of the vertices of guides 122 that are located in regions 134A (or that have a suitable relationship with region 134A—e.g. have a configurable threshold number of vertices in region 134A) may be moved by a displacement given by displacement vector 134B. In another example, only the actual vertices of guides 122 that are located in regions 134A (or have a suitable relationship with region 134A—e.g. have a configurable proximity to region 134A) may be moved by a displacement given by displacement vector 134B.

The user may provide region 134A and displacement vector 134B in any suitable manner. For example, in some embodiments, the user employs a cursor or a touchscreen to input region 134A and displacement vector 134B. The cursor may be controlled by a mouse, joystick, trackball, or another suitable means. The user may select a location of region 134A by hovering the cursor over a portion of a display and clicking, by touching a finger to a touchscreen, by dragging the cursor to outline a location of regions 134A and/or by other suitable means. The size of region 134A may be pre-selected and/or may be user-definable (e.g. by allowing a user to input a radius or other dimension of region 134A before, during or after selecting the location of region). The user may then input a magnitude and direction of displacement vector 134B by, for example, dragging the cursor (or their finger) across the display while continuing to click or touch the screen, as the case may be.

User input 134 may be employed to manipulate guide 122 in step 130 according to any suitable technique. For example, one or more of the methods set out in U.S. patent application Ser. No. 63/163025 filed 18 Mar. 2021, which is hereby incorporated herein by reference, may be employed to manipulate guide 122 based at least in part on user input 134. In some embodiments, user input 134 may be provided to directly prescribe the manipulated locations of the vertices of manipulated guides 132.

Where the step 130 guide manipulation is performed (or received) automatically, such guide manipulation may similarly involve providing a region 134A and displacement vector 134B which may in turn be used to manipulate guides 122 and provide manipulated guides 132 as explained above. In some embodiments, the manipulated locations of the vertices of manipulated guides 132 may be directly prescribed (e.g. by suitable animation/simulation software).

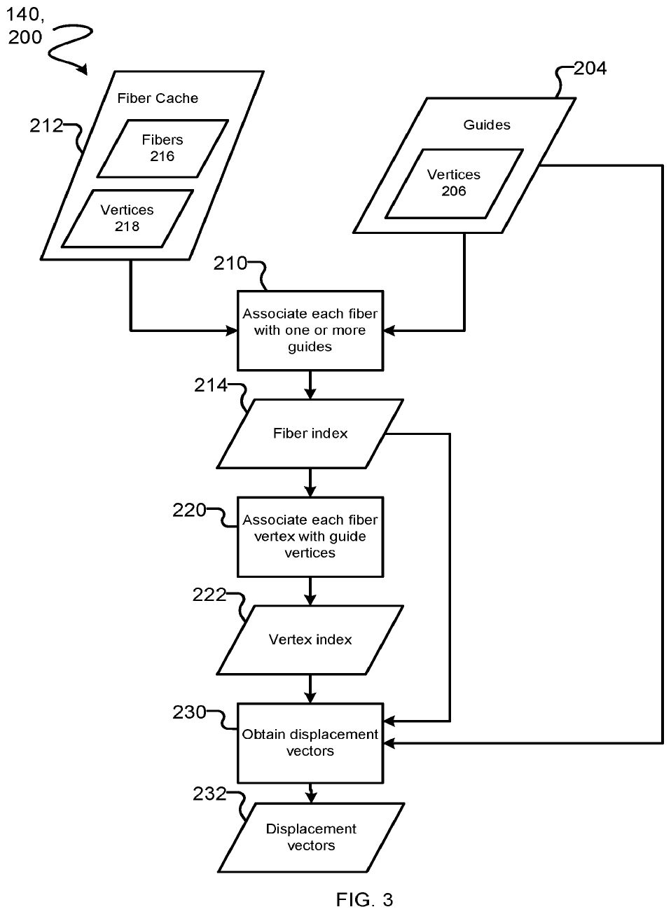

At step 140, manipulated guides 132 are bound to fiber cache 112. Manipulated guides 132 may be bound to fiber cache 112 by employing any suitable method. For example, FIG. 3 depicts a method 200 for binding guides 204 to a fiber cache 112 which may be used in step 140 in accordance with a particular embodiment. In some embodiments, guides 204 used in method 200 comprise manipulated guides 132 and manipulated guides 132 are bound to fiber cache 112 in step 140 according to method 200. As will be explained in more detail below, in some embodiments, guides 204 used in method 200 comprise guides 122 and guides 122 are bound to fiber cache 112 in step 140 according to method 200.

Method 200 starts at step 210. At step 210, a determination is made for each fiber 216 of a fiber cache 212 to determine whether such fiber 216 may be associated with one or more nearby guides 204. Fiber cache 212 may be substantially similar to fiber cache 112 of method 100 (FIG. 1). Guides 204 may comprise manipulated guides 132 from method 100 (FIG. 1). Guides 204 may comprise any other guides (e.g. guides 122) to be bound to fiber cache 212.

Each fiber 216 may be associated with one or more guides 204 based on one or more criteria. In some embodiments, fibers 216 are associated with guides 204 based on root-to-root distance, dᵣᵣ—i.e. between a root of the fiber 216 being evaluated and a root of the guide 204. In some embodiments, for a specific fiber 216 of fiber cache 212, any guides 204 that have a root vertex 206A location within a threshold (which may be a user- or otherwise configurable threshold) radius, r, of the root vertex 218A location of the specific fiber 216 is associated with that specific fiber 216. As such, each fiber 216 in fiber cache 212 may be associated with any number of guides 204 that are within the threshold root-to-root radius. The threshold radius may be chosen to be sufficiently large to ensure that each fiber 216 is associated with at least one guide 204. If no guides 204 are within a threshold radius, r, of the root vertex 218A location of a specific fiber 216, that fiber 216 may be assigned to the guide 204 having the closest root location (root-to-root distance, dᵣᵣ) or that fiber 216 may retain its rest shape (i.e. will not be manipulable) by manipulation of guides 204. In some embodiments, a user may be prompted to change the root-to-root threshold radius r in the circumstance where a fiber 216 has no associated guide 204.

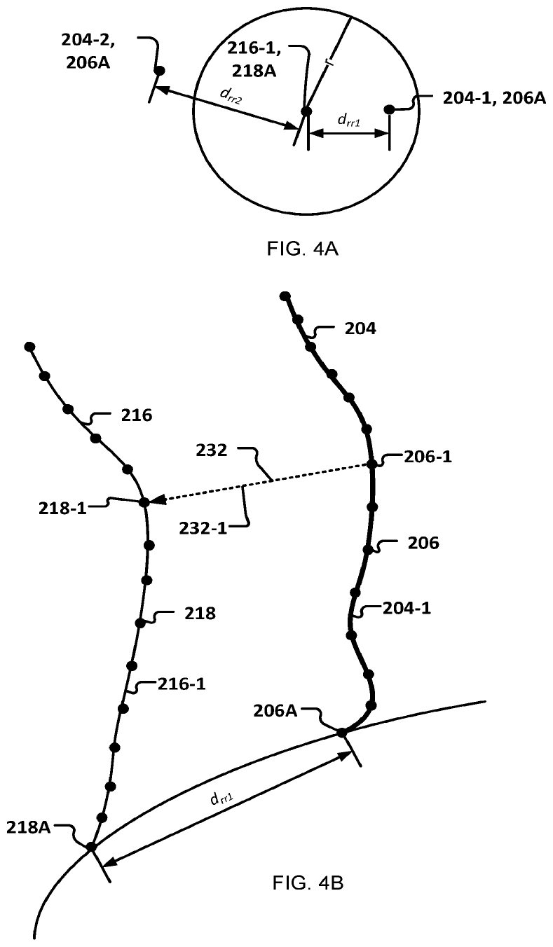

For example, FIG. 4A depicts root vertex 206A locations of exemplary guides 204-1 and 204-2 in relation to the root vertex 218A location of an exemplary fiber 216-1. As can be seen from FIG. 4A, the root-to-root distance, dᵣᵣ₁ between root vertex 218A of fiber 216-1 and root vertex 206A of guide 204-1 is less than threshold radius, r, while the root-to-root distance, dᵣᵣ₂ between root vertex 218A of fiber 216-1 and root vertex 206A of guide 204-2 is greater than threshold radius, r. As such, in step 210, fiber 216-1 would be associated with guide 204-1 and not guide 204-2.

In other embodiments, each fiber 216 may be associated with the N closest guides 204 based on root-to-root distance, dᵣᵣ, where N is a configurable (e.g. user- or otherwise configurable) integer.

Returning to FIG. 3, step 210 may output a fiber index 214. Fiber index 214 may comprise a database or log (or entries in a database or log) indicating which guides 204 are associated with which fibers 206. Fiber index 214 may comprise a binary file or a portion thereof.

For a particular fiber 216, the guides 204 associated with that fiber 216 (in step 210) may be referred to as the “associated guides 204” of fiber 216. At step 220, each vertex 218 of each fiber 216 is associated with a vertex 206 of each of its associated guides 204. In some embodiments, each vertex 218 of each fiber 216 is associated with a closest vertex 206 of each of its associated guides 204.

For example, FIG. 4B depicts vertex 206 locations of exemplary associated guide 204-1 in relation to vertex 218 locations of exemplary fiber 216-1. As can be seen from FIG. 4A, exemplary vertex 218-1 of fiber 216-1 is closest to exemplary vertex 206-1 of associated guide 204-1 as compared to other vertices 206 of associated guide 204-1. Accordingly, vertex 218-1 of fiber 216-1 may be associated with vertex 206-1 of associated guide 204_1. Where fiber 216-1 is associated with more than one guide 204, vertex 218-1 may be associated with an additional vertex 206 for each other associated guide 204. Similarly, where more than one fiber 216 is associated with guide 204-1, additional vertices 218 of such additional fibers 216 may be associated with vertex 206-1 of guide 204-1.

Returning to FIG. 3, step 220 may output a vertex index 222. Vertex index 222 may comprise a database or log (or entries in a database or log) indicating which vertices 206 of guides 204 are associated with each vertex 218 of each fiber 216 of fiber cache 212. Vertex index 222 may comprise a binary file or a portion thereof.

To ensure that guides 204 have vertices 206 that correspond to the vertices 218 of each fiber 216, guides 204 may be re-sampled to obtain new vertex 206 locations for the vertices 206 of guides 204. This resampling of the vertices 206 for guides 204 may be performed prior to the step 220 vertex association process and may make the step 220 vertex association process more efficient. For example, the re-sampled vertices 206 of a guide 204 may be added to a so-called k-d tree and the closest re-sampled vertex 206 to a vertex 218 of fiber 216 may be determined by selecting the closest re-sampled vertex 206 from a search of the k-d tree. The re-sampling process for vertices 206 of guides 204 may depend on (be positively correlated with or proportional to) the length of the guides 204—i.e. longer guides 204 may have a larger number of re-sampled vertices 206 as compared to shorter guides 204, which may have fewer re-sampled vertices 206. The number of re-sampled vertices 206 for each guide 204 may also be stored in vertex index 222.

At step 230, one or more displacement vectors 232 for each vertex 218 are obtained. As explained in more detail below, these displacement vectors 232 may prescribe how the fibers 216 of fiber cache 212 are updated. Specifically, for a given vertex 218 of a given fiber 216 (i.e. a fiber vertex 218), displacement vectors 232 corresponding to each vertex 206 (i.e. each guide vertex 206) of each associated guide 204 are obtained. Each displacement vector 232 may originate at the associated guide vertex 206 and end at the given fiber vertex 218 of the associated guide 204. It will be appreciated that where a fiber 216 has more than one associated guide 204, each vertex 218 of that fiber 216 will have more than one displacement vector 232.

For example, returning to FIG. 4B, an exemplary displacement vector 232-1 for vertex 218-1 is depicted. As can be seen from FIG. 4B, displacement vector 232-1 originates at guide vertex 206-1 and ends at fiber vertex 218-1. If another guide vertex 206 of another guide 204 was also associated with fiber vertex 218-1, then a displacement vector 232 originating at that associated guide vertex 206 and ending at fiber vertex 218-1 would also be obtained as part of step 230.

Method 200 may output fiber index 214, vertex index 222 and/or displacement vectors 232. This output information of method 200 (FIG. 3) may make up the bind information 142 for binding guides 204 to fiber cache 212 that is ascertained in step 140 of method 100 (FIG. 1).

Returning to method 100, step 140 outputs bind information 142. Bind information 142 may comprise a fiber index 142A, a vertex index 142B and associated displacement vectors 142C. In some embodiments, where method 200 is employed at step 140, fiber index 142A, vertex index 142B and associated displacement vectors 142C comprise fiber index 214, vertex index 222 and displacement vectors 232, respectively.

In some embodiments, the output of bind information 142 in block 140 may be the conclusion of method 100. Bind information 142 may then be used when fiber cache 112 is rendered to effect change on fiber system 102 based on user input 134 at the time of rendering (e.g. when experimenting with the look of manipulated fibers) without having to modify fiber cache 112. In some embodiments, bind information 142 is employed when rendering fiber cache 112 in a method similar to that of step 160 (discussed further below) to obtain a rendered fiber system manipulated according to manipulated guides 130 (which, as discussed above, may come from user input 134 and/or a suitable automated or semi-automated animation/simulation process). It may be desirable to output bind information 142 at step 140 rather than update fiber cache 112 at step 160, for example, where fiber cache 112 is used throughout an animation workflow and modifying fiber cache 112 would have indirect effects on other parts of the animation workflow.

In some embodiments, method 100 proceeds to step 160, which involves updating fiber cache 112 based at least in part on bind information 142 to provide updated fiber cache 162. Fiber cache 112 may be updated on a vertex by vertex basis to provide updated fiber cache 162. For a given vertex 106 of a given fiber 104 (i.e. a given fiber vertex 106) of fiber system 102 (FIG. 1), the updated position, p*, of the given vertex 106 may be obtained according to:

p*=Σᵢ₌₁ⁿwᵢ(pᵢ+vᵢ) (Equation 1)

Where i is an associated guide index, n is the number of associated guides for the given fiber 104, pᵢ is the position of the guide vertex of the i^{th} associated guide for the given fiber vertex 106, vᵢ is the displacement vector for the guide vertex of the i^{th} associated guide associated for the given fiber vertex 106 and wᵢ is obtained according to:

$${w}_{i} = \frac{{r}_{i}}{W} \qquad ( Equation 2 )$$

$$where :$$

$${r}_{i} = \frac{1}{\vert {v}_{i} \vert} \qquad ( Equation 3 )$$

$$and$$

$$W = {\sum }_{i = 1}^{n} {r}_{i} \qquad ( Equation 4 )$$

An updated fiber cache 162 may therefore be obtained at step 160 by employing Equation 1 for each vertex 106 of each fiber 104 of fiber cache 112.

Method 100 may output updated fiber cache 162 which is manipulated according to manipulated guides 130 (which, as discussed above, may come from user input 134 and/or a suitable automated or semi-automated animation/simulation process). Updated fiber cache 112 can then be used throughout an animation workflow as desired. In this way, method 100 allows for user manipulation of fiber cache 112 without updating node graph 114 and re-rendering node graph 114 which may be computationally expensive and/or may require undesirable back and forth between multiple artists in an animation workflow.

Method 100 may then proceed to step 170 which involves rendering an image based at least in part on updated fiber cache 162—that is updated fiber cache 162 prescribes the geometry for the hair fibers used in the step 170 rendering. It will be appreciated that the step 170 rendering may involve the use of other information (e.g. about an animate character) to effect the rendering, but the step 170 rendering uses updated fiber cache 162 to prescribe the geometry for the hair fibers step 170. The result of the block 170 is an output frame 172 of an animation. Output frame 172 may be used in an actual animation or may be used by one or more artists to perform shot modelling and/or key framing.

Steps 130, 140 and, optionally, steps 160, 170 may be repeated any suitable number of times to obtain further manipulated guides 132, further updated bind information 142, further updated fiber caches 162 and successive output animation frames 172. Updated fiber cache 162 could be used as input fiber cache 112 for each successive iteration. For example, after obtaining a first updated fiber cache 162 and corresponding animation frame 172, an animator may want to obtain an updated fiber cache 162 and an updated animation frame 172 for a next frame of animation.

Whether method 100 is employed to output bind information 142 at step 140, to update fiber cache 112 to provide updated fiber cache 162 at step 160 and/or provide output animation frame 170 at step 170, method 100 allows for manipulation of fiber cache 112 by using straight-forward (e.g. intuitive) user interface tools, such as a brush tool (e.g. at step 130). As described herein, by allowing for use and manipulation of fiber cache 112, rather than repeatedly updating node graph 114, method 100 allows for reduced computational expense and a more streamlined workflow (e.g. by not repeatedly updating a node graph and therefore updating everything downstream from the node graph) while employing user interface tools (e.g. a brush tool) that are already familiar to many animation artists.

In the illustrated embodiment of method 100 (FIG. 1), step 140 involves binding guides to the other fibers in cache 1122. In the illustrated embodiment of method 100, step 140 involves binding manipulated guides 132 to the remaining fibers in fiber cache 112. In some embodiments, the order of steps 130 and 140 could be reversed. For example, method 100 could involve binding to unmanipulated guides 122 by performing the step 140 binding process on guides 122 and then permitting manipulation of guides 122 by performing the step 130 manipulation process on guides 122 after binding. By implementing step 140 before step 130, an artist may be able to manipulate guides 122 (e.g. with a user interface brush tool or by some other manipulation technique) and then view manipulation of fibers 104, when updated fiber cache 162 is rendered in as output frame 172 in block 170, in real-time.

### Interpretation of Terms

Where a component is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

Unless the context clearly requires otherwise, throughout the description and any accompanying claims (where present), the words “comprise,” “comprising,” and the like are to be construed in an inclusive sense, that is, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, shall refer to this document as a whole and not to any particular portions. Where the context permits, words using the singular or plural number may also include the plural or singular number respectively. The word “or,” in reference to a list of two or more items, covers all of the following interpretations of the word: any of the items in the list, all of the items in the list, and any combination of the items in the list.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method and/or to provide the functionality as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods and/or provide functionality as described herein by executing software instructions in a program memory accessible to the processors.

Software and other modules may reside on servers, workstations, personal computers, tablet computers, image data encoders, image data decoders, PDAs, media players, PIDs and other devices suitable for the purposes described herein. Those skilled in the relevant art will appreciate that aspects of the system can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, network PCs, mini-computers, mainframe computers, and the like.

While processes or steps of some methods are presented herein in a given order, alternative examples may perform routines having steps, or employ systems having steps, in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times. In addition, while elements are at times shown as being performed sequentially, they may instead be performed simultaneously or in different sequences. It is therefore intended that the following claims are interpreted to include all such variations as are within their intended scope.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

1. A method for animating fibers in a computer-based animation process, the method comprising:
obtaining a fiber cache comprising a plurality of fibers, each of the plurality of fibers comprising a plurality of fiber vertices;
obtaining one or more guides, each of the one or more guides comprising a plurality guide vertices;
determining binding information to bind the one or more guides to the fiber cache wherein determining the binding information comprises, for each fiber of the fiber cache:
associating the fiber with one or more nearby guides from among the one or more guides; and
for each of the one or more associated nearby guides:
associating each fiber vertex of the fiber with a nearby guide vertex of the associated nearby guide; and
determining, for each fiber vertex of the fiber, a displacement vector between the fiber vertex and the associated nearby guide vertex.

2. A method according to claim 1 comprising manipulating at least one of the one or more guides, wherein manipulating the at least one of the one or more guides comprises changing a location of one or more guide vertices of the at least one of the one or more guides.

3. A method according to claim 2 wherein manipulating at least one of the one or more guides is based at least in part on user input.

4. A method according to claim 2 wherein manipulating at least one of the one or more guides is based at least in part on an automated animation simulation.

5. A method according to claim 2 wherein manipulating at least one of the one or more guides comprises receiving an indication of a displacement region and a displacement vector.

6. A method according to claim 5 wherein manipulating at least one of the one or more guides comprises displacing the vertices of any guides having one or more vertices in the displacement region by a displacement corresponding to the displacement vector.

7. A method according to claim 5 wherein manipulating at least one of the one or more guides comprises displacing any vertices of any guides located in the displacement region by a displacement corresponding to the displacement vector.

8. A method according to claim 5 wherein manipulating the at least one of the one or more guides comprises changing the location of the one or more guide vertices of the at least one of the one or more guides based at least in part on the indication of the region and the displacement vector according to any one of the methods set out in U.S. patent application Ser. No. 63/163025, filed 18 Mar. 2021.

9. A method according to claim 1 wherein obtaining the one or more guides comprising extracting the one or more guides from the fiber cache by selecting one or more fibers from among the plurality of fibers of the fiber cache to be the one or more guides.

10. A method according to claim 5 wherein extracting the one or more guides from the fiber cache comprises:
filtering out one or more of:
fibers of the plurality of fibers of the fiber cache having a length within, or outside of, a threshold range;
a threshold percentage of fibers of the plurality of fibers of the fiber cache while maintaining a minimum spacing between remaining fibers of the plurality of fibers of the fiber cache;
fibers of the plurality of fibers of the fiber cache having one or more shape characteristics within, or outside of, a range of shape characteristics;
fibers of the plurality of fibers of the fiber cache having a curvature within, or outside of, a range of curvature; and
fibers of the plurality of fibers of the fiber cache that are dissimilar to other nearby fibers of the plurality of fibers of the fiber cache; and
selecting the one or more fibers from among the remaining fibers of the plurality of fibers of the fiber cache to be the one or more guides.

11. A method according to claim 1 wherein:
the plurality of fiber vertices for each of the plurality of fibers comprises a root fiber vertex and one or more other fiber vertices;
the plurality of guide vertices for each of the one or more guides comprises a root guide vertex and one or more other guide vertices; and
for each fiber of the fiber cache, associating the fiber with one or more nearby guides from among the one or more guides comprises identifying, as the one or more nearby guides, any of the one or more guides with root guide vertices that are within a threshold distance of a root fiber vertex of the fiber.

12. A method according to claim 11 wherein the threshold distance is user-configurable.

13. A method according to claim 1 wherein:
the plurality of fiber vertices for each of the plurality of fibers comprises a root fiber vertex and one or more other fiber vertices;
the plurality of guide vertices for each of the one or more guides comprises a root guide vertex and one or more other guide vertices; and
for each fiber of the fiber cache, associating the fiber with one or more nearby guides from among the one or more guides comprises identifying the one or more nearby guides based at least in part on a distance between a root fiber vertex of the fiber and root guide vertices of each of the one or more guides.

14. A method according to claim 13 wherein identifying the one or more nearby guides based at least in part on the distance between the root fiber vertex of the fiber and root guide vertices of each of the one or more guides comprises identifying a threshold number of the one or more guides having the lowest distances between the root fiber vertex of the fiber and the root guide vertices of the guides to be the one or more nearby guides.

15. A method according to claim 14 wherein the threshold number is user configurable.

16. A method according to claim 1 wherein, for each fiber of the fiber cache and for each of the one or more associated nearby guides, associating each fiber vertex of the fiber with a nearby guide vertex of the associated nearby guide comprises, for each fiber vertex of the fiber and for the associated nearby guide, selecting, as the nearby guide vertex, the guide vertex of the associated guide that is closest to fiber the vertex of the fiber.

17. A method according to claim 1 comprising:
updating the fiber cache based at least in part on the binding information to obtain an updated fiber cache, the binding information comprising for each fiber of the fiber cache:
the one or more associated nearby guides; and
for each of the one or more associated nearby guides:
the associated nearby guide vertex for each fiber vertex; and
the displacement vector between each fiber vertex and its associated nearby guide vertex.

18. A method according to claim 17 wherein updating the fiber cache based at least in part on the binding information comprises, for each fiber vertex of each fiber of the fiber cache, obtaining an updated fiber vertex position, p*, according to:
p*=Σᵢ₌₁ⁿwᵢ(pᵢ+vᵢ)
where i is a guide index, n is the number of nearby guides associated with the fiber, pᵢ is the position of the associated nearby guide vertex of the i^{th} guide associated with the fiber vertex of the fiber, vᵢ is the displacement vector between the fiber vertex of the fiber and the associated nearby guide vertex of the i^{th} guide associated with the fiber vertex of the fiber, and wᵢ is obtained according to:
$${w}_{i} = \frac{{r}_{i}}{W}$$
$$where :$$
$${r}_{i} = \frac{1}{\vert {v}_{i} \vert}$$
$$and$$
$$W = {\sum }_{i = 1}^{n} {r}_{i} .$$

19. A method according to claim 17 comprising rendering a frame of animation comprising the plurality of fibers based at least in part on the updated fiber cache.

20. A method according to claim 1 comprising rendering a frame of animation comprising the plurality of fibers based at least in part on the fiber cache and the binding information, the binding information comprising for each fiber of the fiber cache:
the one or more associated nearby guides; and
for each of the one or more associated nearby guides:
the associated nearby guide vertex for each fiber vertex; and
the displacement vector between each associated nearby guide vertex and each fiber vertex.

21. A method according to claim 20 wherein rendering the frame of animation comprising the plurality of fibers based at least in part on the fiber cache and the binding information comprises employing both the fiber cache and the binding information at the time of rendering.

22. A system for animating fibers in a computer-based animation process, the system comprising a processor configured (e.g. by suitable programming) to:
obtain a fiber cache comprising a plurality of fibers, each of the plurality of fibers comprising a plurality of fiber vertices;
obtain one or more guides, each of the one or more guides comprising a plurality of guide vertices;
determine binding information to bind the one or more guides to the fiber cache wherein to determine the binding information, the processor is configured (e.g. by suitable programming) to, for each fiber of the fiber cache:
associate the fiber with one or more nearby guides from among the one or more guides; and
for each of the one or more associated nearby guides
associate each fiber vertex of the fiber with a nearby guide vertex of the associated nearby guide; and
determine, for each fiber vertex of the fiber, a displacement vector between the fiber vertex and the associated nearby guide vertex.

23. A computer program product embodied on a non-transitory computer readable medium having stored thereon software instructions that, when executed by a processor, cause the processor to perform the method of claim 1.
